(19) United States
(12) Patent Application Publication
(10) Pub. No.: US 2003/0146143 A1
(43) Pub. Date: Aug. 7, 2003

(54) High strength, spin-on filter

(75) Inventors: Mark Allen Roll, Bessemer City, NC (US); Willie Luther Stamey JR., Kings Mountain, NC (US)

Correspondence Address: Liniak, Berenato, Longacre & White, Ste. 240, 6550 Rock Spring Drive, Bethesda, MD, 20817, US

(73) Assignee: DANA CORPORATION

(21) Appl. No.: 10/140,344

(22) Filed: May 8, 2002

Related U.S. Application Data
(63) Continuation-in-part of application No. 10/060,348, filed on Feb. 1, 2002.

(51) Int. Cl. B01D 27/08

(52) U.S. Cl. 210/232; 210/443

(57) ABSTRACT

A high strength filter element housing suitable for high pressure hydraulic applications which require a minimum burst rating in the range of about 1,000 psi is comprised on an externally threaded tubular portion formed with a dome as a unitary piece having an open end closed by an internally threaded base. The base has a central opening which is threaded so that the filter element housing mounted as a spin-on housing for use with annular filter elements, the base further having spaced central openings around the threaded central opening. In a preferred embodiment, the base is permanently fixed to the tubular portion by adhesive sealing material disposed between the threads attaching the base and cap to the tubular portion.

This is a continuation-in-part of application Ser. No. 10/060,348 filed on Feb. 1, 2002.

### BACKGROUND OF THE INVENTION

1. Field of the Invention

The present invention relates to high strength spin-on filters. More particularly, the present invention relates to high strength spin-on filters that are capable of withstanding pressures in the range of 1,000 pounds per square inch (PSI) and higher.

2. Description of Related Art

Spin-on filters are used in numerous liquid and pneumatic applications throughout vehicular, industrial and agricultural industries. For hydraulic applications there is a need for high strength filter housings which are disposable, or perhaps even recyclable, and have burst pressure ratings in the 1,000-PSI range. In other words, the housing is capable of withstanding pressures on the order of 1000 PSI and higher. Generally, filters of this type tend to be relatively expensive because they are made by techniques which have been developed for disposable filter cans, wherein the cans are made by deep-draw forming of malleable metals. Cast steel cover plates are used and assembled to a tubular housing portion by deforming the housing portion. Consequently, these filters tend to be complex, adding to production and overall expenses in order to insure that the filters are of a reliable quality. Ruptures of filter housings containing fluid pressures in excess of 500 PSI can cause substantial damage to both people and adjacent equipment.

The typical filter assembly has a housing which contains a filter element used for filtering the fluid as it circulates through the housing. Ordinarily, the housing has an end adapted for pairing the filter assembly to a base member from which the fluid will flow by means of an internally threaded fluid exit port that threads onto a corresponding externally threaded configuration on the base. The housing also has another end which is ordinarily closed. The fluid exit port is ordinarily centrally located in the housing cover which is permanently, peripherally attached to the first end of the housing. Contaminated fluid flows into the filter housing through fluid inlet holes located in the cover and surrounding the fluid exit port, and clean, filtered fluid flows out of the filter housing through fluid exit port. The filter housing is sealed against the base member by using an elastomeric gasket which surrounds the inlet holes and the exit port.

In view of the above-mentioned expense and failure rates, there is a need for low cost, high reliability spin-on filters of high strength for filtering high pressure hydraulic fluids, exceeding 1000 PSI, and other high pressure fluids.

### SUMMARY OF THE INVENTION

The present invention is directed to a high pressure filter element housing adapted to contain an annular filter element, wherein the housing comprises a tubular portion having an externally threaded first ends and a second formed as an integral dome. In order to close the housing, a base with an internally threaded periphery is threaded into the first end of the tubular portion.

In a further aspect of the invention, a thread sealant is disposed between the externally threaded periphery of the base and the internally first end of the housing.

In still another aspect of the invention, the thread sealant is an adhesive sealant which permanently secures the base and end cap to the tubular housing.

It is yet another aspect of the present invention to provide a non-reusable fluid filter assembly comprising a can body, a base member, a locking sealant, and a filter element. The can body has side walls and a closed bottom formed as a unitary, one-piece member. The side walls have a thickness greater than 5 nm. The can body further comprises an open end having external threads formed thereon. The base member has internal threads adapted to mate with the external threads of the can body. The base member also has at least one fluid inlet and at least one fluid outlet passing. The locking sealant is disposed between the internal threads and external threads to lock the base member to the can body. The filter element is disposed within the can body and is designed to withstand an internal pressure of about 1000 PSI.

These and other benefits will be apparent with reference to the following detailed description and associated drawings which exemplify the underlying principles of the instant invention.

### BRIEF DESCRIPTION OF THE DRAWINGS

FIG. 1 is a partial side elevation of the present invention in combination with an annular filter element;

FIG. 2 is an end view of the tubular portion of the housing;

FIG. 3 is a side elevation of a tubular portion of the housing taken on long lines 3-3 of FIG. 2;

FIG. 4 is a perspective view of a base;

FIG. 5 is an end view of the base;

FIG. 6 is a partial side elevation of an alternate embodiment of the present invention;

FIG. 6 is a perspective view of an end cap; and

FIG. 7 is a side elevation of the end cap.

### DETAILED DESCRIPTION OF THE PRESENT INVENTION

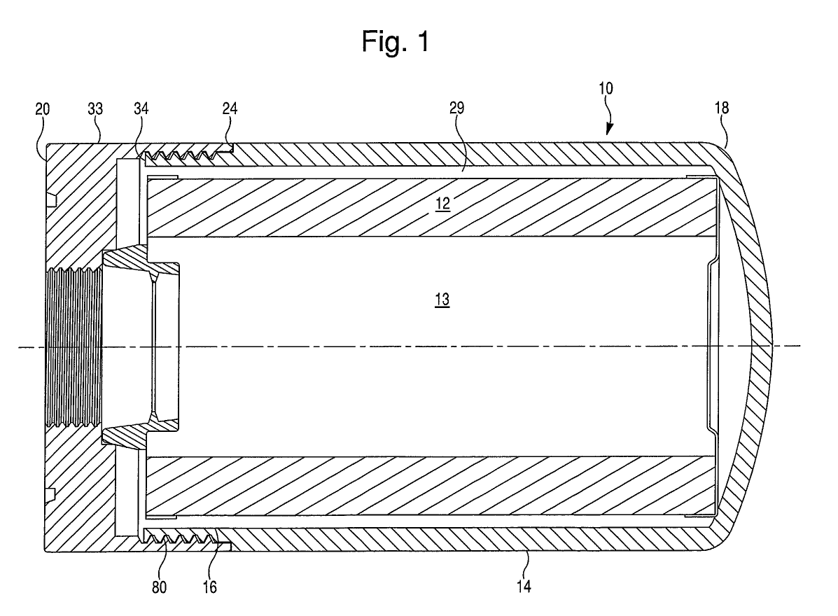

Referring now to FIG. 1, there is shown a filter element housing 10 configured in accordance with the principles of the present invention which has therein an annular filter element 12 with a hollow core 13. The filter element housing 10 is configured for high pressure applications wherein the burst strength of the filter element housing has a rating of at least 1,000 pounds per square inch (“psi”) which means that the average high pressures are generally about 500 psi. The housing 10 is used for containing filter elements 12 used to filter hydraulic fluid. However, the present invention is not limited to hydraulic fluid, in fact other high pressure fluids, either liquid or gas, can be filtered within the filter element housing. Examples of other fluids include but are not limited to fuels, lubricating oil and highly compressed air.

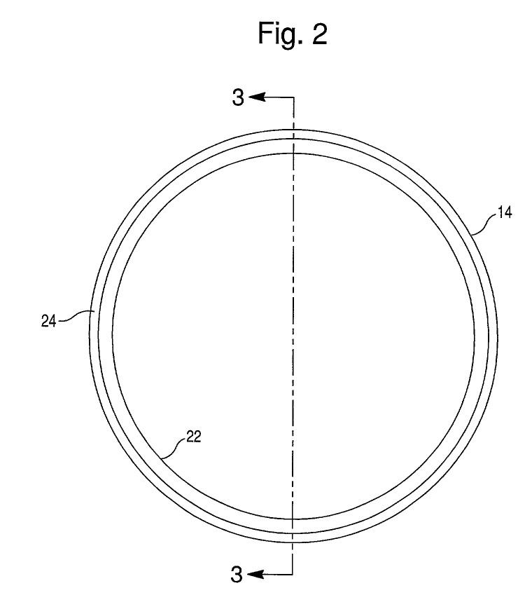

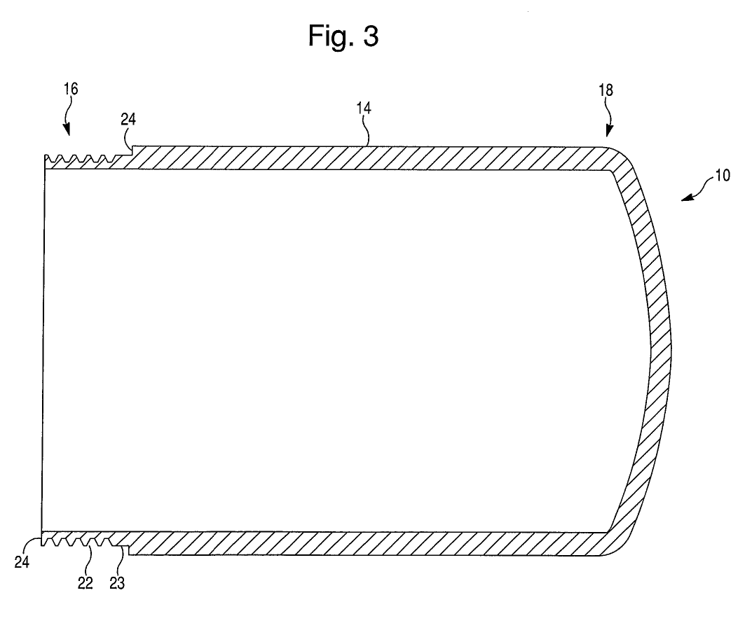

Referring now to FIGS. 2 and 3, there is shown a tubular portion 14 of the housing 10 which has a first end 16 and a second end 18. The second end 18 is formed integrally with the tubular portion 14 during manufacturing. The tubular portion 14 has an open end 16 which is externally threaded to receive a base 20.

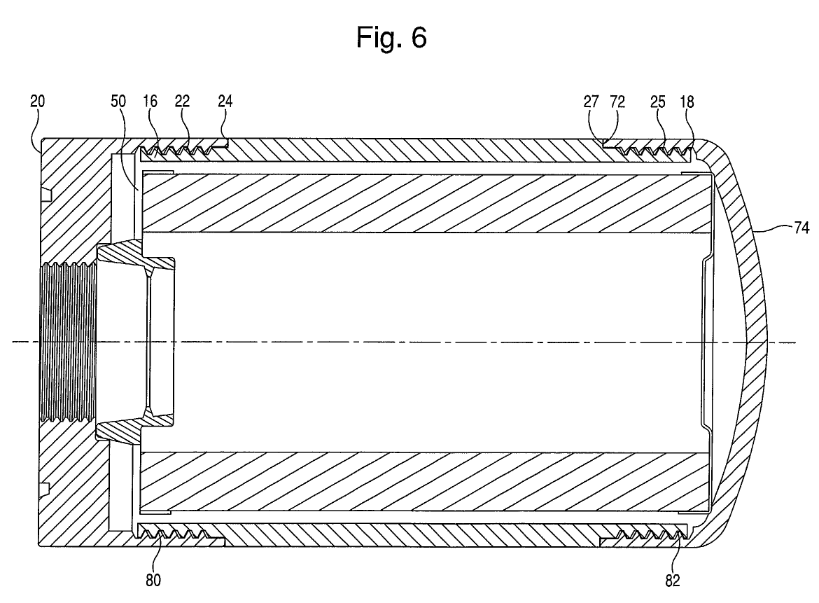

In an alternate embodiment seen in FIG. 6, the tubular portion 14 has an open end 18 for receiving an end cap 74 discussed herein. In the alternate embodiment, both open ends 16 and 18 are externally threaded to receive a base 20 and the end cap 74, best shown in FIG. 6. The tubular portion 14 is generally circular wherein the first end 16 and the second end 18 have the same diameter. However, it is not essential that the diameters of the first end 16 and the second end 18 be the same.

Referring now to FIGS. 1, 2 and 3, the tubular portion 14 has external threads 22 at its first end 16 which start inboard of an unthreaded portion 23 which extends back from a flat annular first end edge 24 of the tubular portion 14. The tubular housing 14 is preferably about ⅛ of an inch in thickness and defines a cylindrical space 29 which receives the annular filter element 12, shown in FIG. 1.

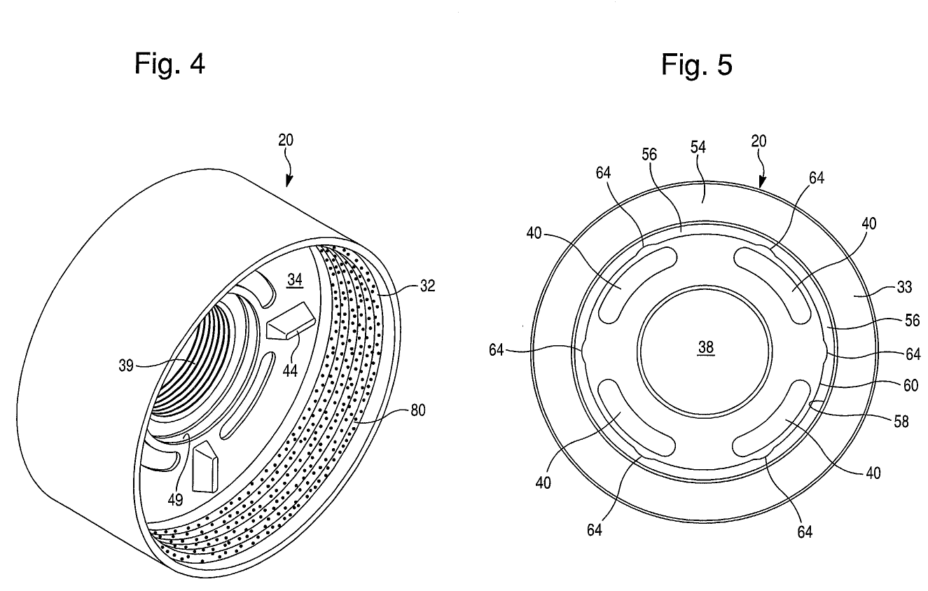

Referring now to FIGS. 4 and 5, the base 20 of the present invention is shown in isolation. The base 20 has internal annular threads 32 which threadingly engage with the external annular threads 22 of the tubular portion 14 and has an outer flange portion 33 that includes an annular shoulder 34. The shoulder 34 engages the first end edge 24 of the tubular portion 14 when the base 20 is threaded into the first threaded end portion 16. The diameter of the flange 33 is slightly larger than that of the outside diameter of the tubular portion 14 so that the base 20 overlaps the tubular portion 14. Since the shoulder 34 abuts the end edge 24 of the tubular portion 14, a very tight friction fit is obtained between the base 20 and the tubular portion 14. That the base 20 overlaps the tubular portion 14, permits adds strength leading to a higher busting pressure.

The base 20 has a central opening 38 which has threads 39 that allow the base 20 to receive a stand pipe (not shown) and thus mount the filter housing 10 as a spin-on filter. The central opening 38 can be either an inlet for the fluid to be filtered or an outlet for filtered fluid depending on the interface with the machine which is utilizing the fluid. The diameter of the central opening 38 may vary depending upon the stand pipe dimensions. Disposed around the central opening 38 are radially spaced openings 40. The openings 40 are oblong and arcuate and can act either as fluid inlets or fluid outlets. The openings 40 are generally similar in size and equally spaced apart on the base 20. The preferred embodiment has four such openings 40, however, any number of openings may be used depending on design requirements or manufacturing preference. Located between each of the openings 40 is a spacer tab 44. The spacer tabs 44 maintain a gap 47, seen in FIG. 1, between the filter element 12 and the inside surface 45 of the base 20. FIG. 1 illustrates the base 20 fixed to the tubular portion 14.

Referring to FIG. 4, a sealing grommet (not shown) is seated in a relieved portion 49 to support the annular filter element 12. When the fluid creates a high pressure within the space 29, the filter element 12 is pushed toward the base 20. Therefore, the tabs 44 insure that space 50 is maintained between the filter element 12 and the surface 45 of base 20 despite the pressure buildup as shown in FIG. 1. The tabs are not essential to the invention, so long as a means is employed to insure that space 50 is maintained. Alternative means would include an independent space assembled with filter, tabs fabricated on the filter element itself, or other means to accomplish the same.

Referring now to more specifically FIG. 5, the base 20 has an outside surface 54 that has a channel 56 thereby defined by a wall 58 and an inner wall 60. Between the wall 58 and an inner wall 60, the channel 56 receives an elastomeric ring (not shown) to seal the base with the machine upon which the filter element 10 when mounted. A plurality of projections 64 are provided to hold the elastomeric ring in place in the channel 58 so that the elastomeric ring does not dislodge when the housing 10 is not mounted on a machine.

In alternative embodiment as best shown in FIGS. 6-8, the tubular portion 14 has an end cap 21 rather than have a dome end integrally formed. The end cap 21 has internal peripheral threads 70 that engage the external threads 25 of the tubular body at the second end 18 of the tubular portion 14 to hold the end cap 21 within the second end of the tubular portion, see FIG. 6.

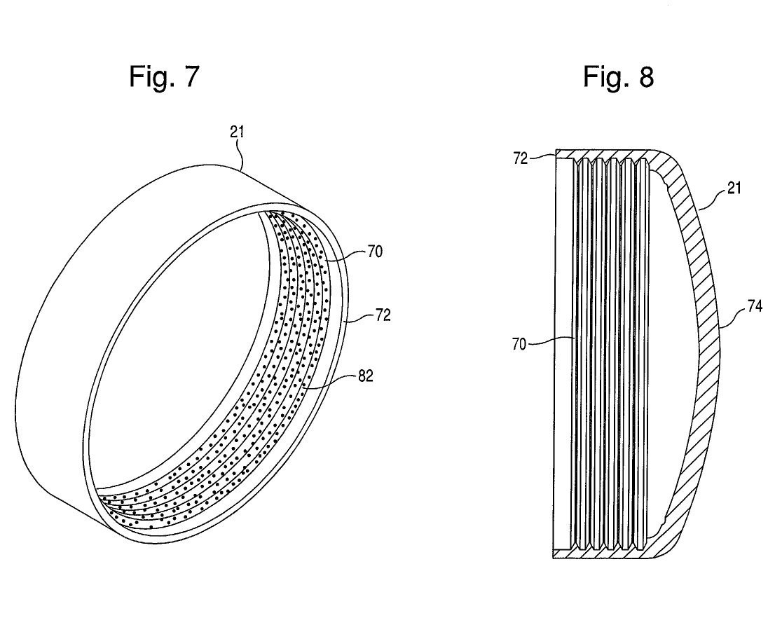

As seen in FIGS. 7 and 8, the end cap 21 also has an axially facing shoulder 72 toward the external peripheral threads 70 which engages the second end edge 27 so that there is a tight friction fit between the end cap 21 and the tubular portion 14. Since the end cap 21 has a substantially diameter equal to the outer diameter of the tubular portion 14, the integration results in a flush surface. In order to have a smooth exterior surface, the end cap 21 has a domed end surface 74. It should be noted that the end cap need not be dome shaped. A flat planar surface may also be employed on the end cap and still remain within the scope and spirit of the invention.

In order to prevent fluid leakage during filtration, a sealant layer 80, shown in FIG. 4, is placed between the external threads 22 of the tubular portion 14 and the internal threads 32 of the base 20. In the alternate embodiment shown in FIG. 7, a sealant layer 82 is also placed between the internal thread 25 of the tubular portion 14 and the external thread 70 of the end cap 21. In the preferred embodiment, sealant 80 as shown in FIG. 1 is made from a two part epoxy, however a single component anaerobic material may also be used. The sealant 80 forms a permanent bond so that the housing 10 is incapable of opening. In the alternate embodiment, sealant 82 exhibits the same characteristics as sealant 80. These types of adhesive sealants require a temperature of 650° F. before termination of their bonding strength, accordingly as a practical matter, this filter housing 10 cannot be reused by the customer. However, sealants 80 and 82 which release at lower temperatures may also be used so that housings 10 may be reused by replacing filter elements 12 with fresh filter elements by removing one end of the housing. Such a recycling program could be effected by returning used filters to a processing location so that the filter element could be replaced and a fresh filter element and returned to the customer enclosed in the same housing.

As an example, the preferred embodiment of the filter housing 10 has a diameter of 3.5 inches and is either 6.5 or 9.5 inches in length. The wall of the tubular portion 14 has a thickness of ⅛ of an inch. Tests have indicated that steel used as the tubular portion have withheld under internal pressures of approximately 2,000 psi without leakage. Aluminum tubular housing prototypes begin to experience leakage through the threads between the cap and tube at approximately 1,200 psi. Either material meet the minimum static burst requirement of 1,000 psi required for the tubular housing. It should be appreciated that it may be possible to utilize a plastic tubular portion that is capable of withstanding the target pressures.

From the foregoing description, one skilled in the art can easily ascertain the essential characteristics of this invention, and without departing form the spirit and scope thereof, can make various changes and modifications of the invention to adapt it to various usages and conditions. For example, the tubular housing and the end cap can be formed as a single unitary member.

We claim:

1. A fluid filter assembly comprising:
a can body having side walls and a closed bottom, said can body further comprising an open end having external threads formed thereon;
a base member having internal threads threadably engageable with said external threads of said can body, said base member further comprising at least one fluid inlet and at least one fluid outlet passing therethrough;
a locking sealant disposed between said internal and external threads to lock said base member to said can body; and
a filter element disposed within said can body, wherein said filter assembly is designed to withstand an internal pressure of at least about 1000 pounds per square inch.

2. The fluid filter assembly according to claim 1, wherein said closed bottom is formed as a unitary, one-piece member with said can body.

3. The fluid filter assembly according to claim 1, wherein said closed bottom comprises an end cap having internal threads threadably engageable with external threads of said can body located opposite of said open end.

4. The fluid filter assembly according to claim 3, wherein the base and cap each have a peripheral shoulder which abuts a respective end edge of said can body.

5. The fluid filter assembly according to claim 3, wherein said locking sealant is further disposed between said internal threads of said end cap and said external threads of said can body to lock said end cap to said can body.

6. The fluid filter assembly according to claim 3, wherein the base and cap each have a peripheral shoulder which abuts a respective end edge of said can body.

7. The fluid filter assembly according to claim 1, wherein said locking sealant can withstand temperatures greater than 600 degrees Fahrenheit.

8. The fluid filter assembly according to claim 1, wherein said base member has a plurality of spacers disposed along a surface of inner surface thereon to maintain a gap between said filter element and said base member.

9. The fluid filter assembly according to claim 1, wherein said can body is formed of a material selected from the group consisting of steel, aluminum, and plastics.

10. The fluid filter according to claim 1, wherein said base member has an annual channel disposed in the circumferential direction on a surface facing away from said can body for receiving an elastomeric ring.

11. The fluid filter according to claim 10, wherein said elastomeric ring seals said base member against a machine.

12. The fluid filter according to claim 1, wherein said side walls have a thickness of greater than 5 millimeters.
